(19) United States
(12) Patent Application Publication
(10) Pub. No.: US 2007/0011738 A1
(43) Pub. Date: Jan. 11, 2007

(54) Memory aid for remembering passwords

(76) Inventor: Brian L. Doss, Apopka, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/482,630

(22) Filed: Jul. 7, 2006

Related U.S. Application Data
(60) Provisional application No. 60/697,584, filed on Jul. 8, 2005.

(51) Int. Cl. H04L 9/32

(52) U.S. Cl. 726/18

(57) ABSTRACT

In a matrix of password characters organized into rows and columns, the characters being selectively combinable to form passwords, the matrix having a plurality of column indices identifying respective columns of the matrix and a plurality of row indices identifying respective rows of the matrix, a method for remembering passwords includes selecting a first password from among the password characters and identifying an anchor character of the first password by its corresponding row and column index. The method also includes determining the anchor character's matrix location relationship with other characters of the first password. The method further includes retrieving the desired password from the matrix by locating the anchor character according to its corresponding row and column index and by using the anchor character's matrix location relationship with the other characters of the first password so that knowledge of respective matrix locations of the other characters of the first password is not required.

### SPECIFIC DATA RELATED TO THE INVENTION

This application claims the benefit of U.S. Provisional Application No. 60/697,584 filed Jul. 8, 2005.

### FIELD OF THE INVENTION

The invention generally relates to the field of computers, and, more particularly, to a memory aid for remembering passwords for computers.

### BACKGROUND OF THE INVENTION

Passwords are commonly used to grant access to secured systems. For example, computer systems, such as home computers, enterprise computing systems in the workplace, and automatic teller machines (ATM's), are commonly access-restricted using passwords. Remembering such passwords, which may differ according to a computer system being used and functions being accesses, can be difficult, especially since more easily remembered passwords may be easier to compromise than random combinations of letters, numbers, and symbols. Accordingly, systems administrators often require user requesting access to a system to remember complex passwords that include a certain minimum number of characters having a required combination of letters, numbers and symbols. In addition, passwords my need to be changed on a periodic basis, for example, to foil hackers, making remembering constantly changing passwords even more difficult.

### BRIEF DESCRIPTION OF THE DRAWINGS

FIG. 1 shows an exemplary embodiment of a memory aid for remembering a password.

FIG. 2 shows an exemplary embodiment of a memory aid including an embodiment of a windowing element.

FIG. 3 shows an exemplary embodiment of a memory aid including another embodiment of a windowing element.

FIG. 4 shows an exemplary embodiment of a memory aid including row identifying indicia.

### DETAILED DESCRIPTION OF THE INVENTION

The present invention provides a memory aid for remembering passwords that may be used to access password secured systems, such as computers. In an exemplary embodiment, the memory aid includes a code key, such as a matrix of password characters, each character being indexed, for example, by a row and column identifier. Passwords are formed from strings of combined characters of the matrix, such as adjacent characters in a horizontal, vertical, or diagonal direction. A selected password may wrap around the matrix as required. The characters of a password may be selected and arranged so that required password constituents, such as certain numbers, letters, and/or symbols, are included in a selected string of characters used to form a password. A user of the memory aid need only remember indices to a string of password characters, instead of having to remember the string of password characters itself.

For example, a user may access his password by remembering a row and column identifier of an anchor character, such as the first character of the user's selected password. The password may then be read as the characters following the first character in a horizontal, vertical, diagonal, or some other predetermined pattern or direction. If the password needs to be changed, the user may select a different anchor character indicative of a different password. The user is then only required to remember the new indices of the new anchor character, instead of the entirely new password. The memory aid may be updated periodically to provide new combinations of characters. Advantageously, the memory aid may be publicly displayed while preserving password privacy and helps reduce a propensity of system users to write down passwords to remember them.

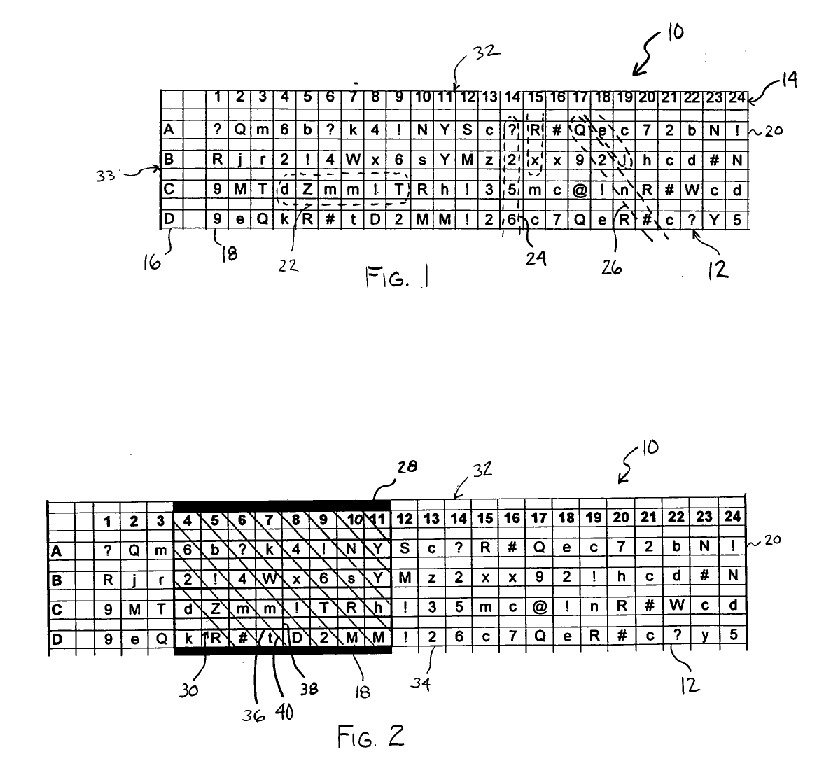

In an embodiment of invention depicted in FIG. 1, the memory aid 10 includes a matrix 12 of password characters such as may be used to form passwords. The characters may be arranged and selected so that they are combinable to form passwords having certain required password characters, such as password having at least one non-alphanumeric symbol. The memory aid 10 may also include a plurality of column indices 14 identifying respective columns of the matrix 12 and a plurality of row indices 16 identifying respective rows of the matrix 12. Accordingly, a user may retrieve a desired password from among the characters of the matrix 12 by referencing a row index and a column index corresponding to at least one character of the desired password. Consequently, a user is not required to remember a matrix location of each character of the desired password. In an embodiment of the invention, the matrix 12 may include a single row 20 of characters with a plurality of column indices 14 identifying respective columns of the single row, or may include a single column 18 of characters with a plurality of row indices 14 identifying respective rows of the single column.

The memory aid 10 may be printed on an appropriately sized piece of paper, cardboard, plastic, or other printable medium, that may be kept conveniently in a vicinity of a system, such as a computer system requiring password access. For example, the memory aid 10 may be sized to be displayed on a computer keyboard or a computer monitor for convenient reference. The memory aid 10 may include an adhesive backing to allow mounting of ht e aid to appropriate surfaces, for example, on or near a computer workstation. In an example embodiment, the memory aid 10 may be about 12 inches long by about 2.5 inches high.

In an aspect of the invention, the column indices may include a row of numbers across a top 32 of the matrix corresponding to the respective columns 18 of the matrix 12. The memory aid 10 may also include a column of letters down the side 33 of the matrix 12 corresponding to the respective rows 20 of the matrix 12. The matrix 12 may include alphabet letters, both upper and lowercase, numbers, and/or symbols arranged in a pseudo-random pattern, meaning that the combination of letters, numbers, and characters themselves are random throughout the matrix, but are arranged in the matrix 12 so that when passwords of a required character length are formed by grouping sequences of adjacent characters, a required character constitution of the password is generated. For example, if a password is required to have at least six characters, wherein one of the characters is required to be a symbol, the characters are arranged in the matrix 12 such that any sequential selection of six characters will form a password having at least one of the required symbols. As can be seen in FIG. 1, a six character password beginning at an anchor character “?” at Row A, Column 1 (Al) reads “?Qm6b?” and includes a variety of upper case and lower case alphabet characters, a numeral, and a symbol, each of which may be required to constitute a password.

To use the memory aid 10 to remember a password, a user initially selects a desired password from among the password characters, such as a string of characters extending in a horizontal, vertical, or diagonal direction that contains a number of required characters. When a predetermined length password cannot be obtained by proceeding in a desired direction before reaching an edge of the matrix 12, the user may wrap the password around the matrix 12, for example, as shown by password 24, 26 of FIG. 1

The user may select a password character length based on a requirement of an access control organization such as an Information Technology department, such as a minimum password character length. For example, a user may select the password “dZmm!T” 22 beginning on Row C, Column 4. The user then identifies an anchor character of the desired password, such as the first character “d,” by its corresponding row and column index, i.e. C4. The user than determines the anchor character's matrix location relationship with other characters of the desired password. In the present example, the user knows that anchor character “d” has been selected as the first character of the password, knows that he has chosen six characters, possibly the minimum number of characters required for a password, and knows that the password extends in a horizontal direction from the first character. Accordingly, the user may retrieve the desired password by, locating the anchor character according to its corresponding row and column index and by using the anchor character's matrix location relationship with the other characters of the desired password. In the present example, the password “Zmm!T” 22 is retrieved by locating the known anchor character at C4 and recreating the password knowing “d” is the first letter of a six character password extending in a right hand direction from anchor character “d.”

When it becomes necessary to change a password, such as might be required on a periodic basis, a new password my be generated by simply moving one column 18 to the right to assign a new anchor character and assembling a new password based on the new anchor character. For example, the anchor character at C4 may be changed to an anchor character in an adjacent column at C5, thereby generating password “Zmm!TR.” By moving the anchor character one character to the right of a previous anchor character, a new character of the password is added to the end of the password and an old character is deleted from the beginning of the password so that the remaining original characters may have already been already memorized by a user. Accordingly, the characters in the matrix 12 may need to be arranged so that a password content requirement, such as certain required letters, numerals or symbols, would be fulfilled when selecting a password from adjacent characters of the matrix, such as with each consecutive move to the right.

In an aspect of the invention embodiment, passwords, such as password “?256Rx” 24, may be generated in a vertical direction that wraps around the matrix 12. In yet another aspect, passwords, such as password “Q2n#e!” 26, may be generated in a diagonal direction that wraps around the matrix 12. Because of the many different password combinations and combination orientations that may be selected, it would be difficult to guess which combination the possessor of the grid has selected for use as a password in an attempt to gain unauthorized access using the selected password.

The memory aid 10 allows a user may to be creative in its use. For example, depending on requirements of an Information Technology department or governing entity controlling access to computers using passwords, the length of the password may be varied to a minimum or maximum password length requirement according to a user's desire.

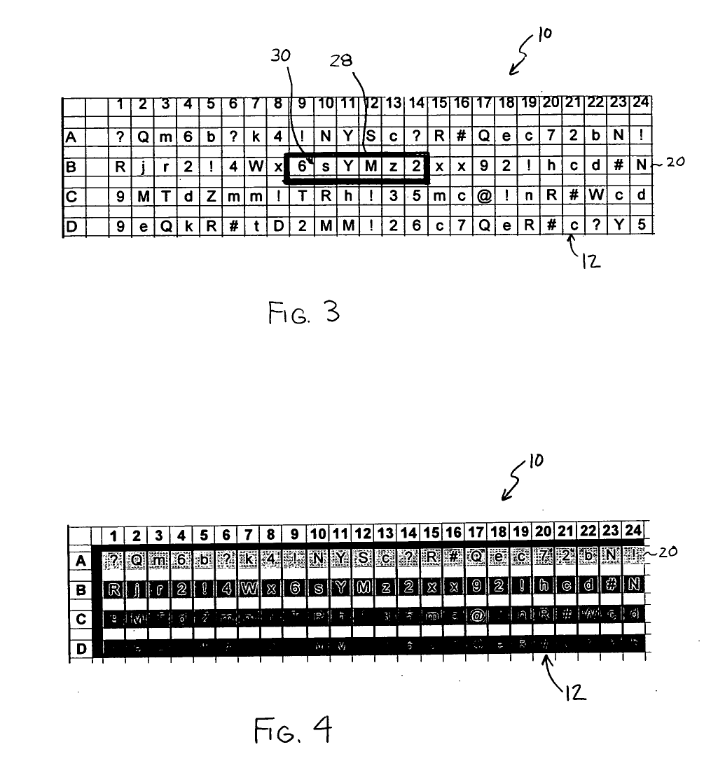

In other embodiments depicted in FIGS. 2 and 3, the memory aid 10 may include a windowing element 28 positionable over the matrix 12 to window a portion 30 of the matrix 12 comprising a desired password by aligning the windowing element 28 over the matrix 12. The windowing element 28 may be aligned with respect to the row index and the column index corresponding to a selected anchor character. The windowing element 28 may be sized to show a predetermined pass word character length, such as sized to reveal 8 characters in a horizontal row as shown in FIG. 2, or six characters in a horizontal row as shown in FIG. 3. The windowing element 28 may provide a degree of magnification to aid in viewing windowed password characters.

In the embodiment depicted in FIG. 2, the windowing element 28 may extend from a top edge 32 to a bottom edge 34 of the memory aid 10 and may be slidable along these edges 32, 34 to reveal a selected password, for example, in a horizontal row 20 of the portion 30 of matrix 12 revealed by the windowing element 28. The windowing element 28 may be formed from a clear material, such as a clear plastic, to allow viewing the matrix 12 under the windowing element 28. In addition, the windowing element 28 may include grid lines, such as horizontal grid lines 36, vertical grid lines 38, and/or diagonal grid lines 40 to aid in lining up the characters of a selected password according to a desired direction of password assembly. In another aspect of the invention, the widowing element 28 may be configured to obscure characters not used for forming a password, such as by obscuring rows other than a row that contains a user's password.

In the embodiment of shown in FIG. 3, the windowing element 28 may be sized to reveal a desired password from among the other characters of the matrix 12. For example, to window a six character, horizontally arranged password selected from the matrix, the widowing element 28 may be sized appropriately to reveal only the six characters in a selected row. The windowing element 28 may movable around the matrix 12 to highlight a desired password when needed, and then moved to a different position after reading the desired password. In an embodiment, the windowing element 28 may be formed from a transparent material that is configured for removably adhering to a surface of the memory aid 10.

In another embodiment, the matrix 12 may include row and column identifying indicia, such as different colored coded rows, as indicated in FIG. 4 by the different shading of the rows 20. In another aspect, the columns may differently colored. The indicia of the rows and/or columns may further aid a user in remembering a password location in the matrix by remembering an indicia, such as a color of a row and/or column where an anchor character is located.

While various embodiments of the present invention have been shown and described herein, it will be obvious that such embodiments are provided by way of example only. Numerous variations, changes and substitutions may be made without departing from the invention herein.

I claim:

1. In a matrix of password characters organized into rows and columns, the characters being selectively combinable to form passwords, the matrix having a plurality of column indices identifying respective columns of the matrix and a plurality of row indices identifying respective rows of the matrix, a method for remembering passwords comprising:
selecting a first password from among the password characters;
identifying an anchor character of the first password by its corresponding row and column index;
determining the anchor character's matrix location relationship with other characters of the first password; and
retrieving the desired password from the matrix by locating the anchor character according to its corresponding row and column index and by using the anchor character's matrix location relationship with the other characters of the first password so that knowledge of respective matrix locations of the other characters of the first password is not required.

2. The method of claim 1, further comprising, when the first password has expired, selecting a second password based on a different anchor character.

3. The method of claim 1, wherein selecting comprises choosing a string of adjacent characters of the matrix extending in at least one of a horizontal, vertical and diagonal direction to form the first password.

4. The method of claim 3, further comprising wrapping around the matrix when a predetermined length password cannot be obtained by proceeding in a desired direction before reaching an edge of the matrix.

5. A password memory aid comprising:
a matrix of password characters organized into rows and columns, the characters selectively combinable to form passwords;
a plurality of column indices identifying respective columns of the matrix; and
a plurality of row indices identifying respective rows of the matrix, the column indices and the row indices allowing a user can retrieve a desired password from among the characters of the matrix by referencing a row index and a column index corresponding to at least one character of the desired password to aid the user in retrieving the desired password without requiring the user to remember a matrix location of each character of the desired password.

6. The memory aid of claim 5, wherein the password characters are arranged in the matrix to ensure that a predetermined password character constituent requirement is met when a password is selected from adjacent characters of the matrix.

7. The memory aid of claim 5, wherein the rows further comprise different row indicia for distinctly identifying each of the rows.

8. The memory aid of claim 7, wherein the row indicia comprise different colors.

9. The memory aid of claim 5, wherein the columns further comprise different column indicia for distinctly identifying each of the columns.

10. The memory aid of claim 9, wherein the column indicia comprise different colors.

11. The memory aid of claim 5, further comprising a printed medium.

12. The memory aid of claim 11, further comprising an adhesive backing.

13. A password memory aid comprising:
a matrix of password characters organized into rows and columns, the characters selectively combinable to form passwords;
a plurality of column indices identifying respective columns of the matrix; and
a plurality of row indices identifying respective rows of the matrix so that a user can retrieve a desired password from among the characters of the matrix by referencing a row index and a column index corresponding to at least one character of the desired password to aid the user in retrieving the desired password; and
a windowing element positionable over the matrix to window a portion of the matrix comprising the desired password by aligning the windowing element over the matrix with respect to the row index and the column index corresponding to the at least one character.

14. The memory aid of claim 13, wherein the password characters are arranged in the matrix to ensure that a predetermined password character constituent requirement is met when a password is selected from adjacent characters of the matrix.

15. The memory aid of claim 13, wherein the windowing element comprises a plurality of grid lines extending in at least one of a horizontal, vertical and diagonal direction to aid in viewing the dressed password.

16. The memory aid of claim 13, wherein the windowing element extends from a top edge of the aid to the bottom edge of the aid and is slidable along the top and bottom edges of the memory aid.

17. The memory aid of claim 13, wherein the windowing element is sized to window a predetermined number of characters.

18. The memory aid of claim 17, wherein the predetermined number of characters comprises a required password character length.
